(19) United States
(12) Patent Application Publication
(10) Pub. No.: US 2014/0101751 A1
(43) Pub. Date: Apr. 10, 2014

(54) HARDWARE ENGINE FOR HIGH-CAPACITY PACKET PROCESSING OF NETWORK BASED DATA LOSS PREVENTION APPLIANCE

(71) Applicant: SOMANSA CO., LTD., Seoul (KR)

(72) Inventors: Sang Seok LEE, Seoul (KR); Seung Tae PAEK, Seoul (KR); Tae Wan KIM, Seoul (KR); Il Hoon CHOI, Seoul (KR)

(73) Assignee: SOMANSA CO., LTD., Seoul (KR)

(21) Appl. No.: 14/048,686

(22) Filed: Oct. 8, 2013

(30) Foreign Application Priority Data
Oct. 9, 2012 (KR) 10-2012-0111983

(51) Int. Cl. H04L 29/06

(52) U.S. Cl. CPC H04L 63/0245
USPC 726/13

(57) ABSTRACT

Provided is a network-based data loss prevention (DLP) system. The network-based DLP system includes a FPGA engine including a pattern matcher and a MCP engine including a session list filter. The a pattern matcher hash-processes a payload of an input packet in units of a certain size, compares a pre-stored pattern and the hash-processed packet, checks a matching rule ID and an upload channel ID corresponding to the pre-stored pattern when there is a match therebetween, adds tagging information to a header of the input packet, and outputs the packet. The session list filter receives the packet with the tagging information added thereto, and performs pre-registered processing on the pre-registered session, or passes the received packet. The processor uploads, forwards, or drops the received packet in correspondence with the matching rule ID.

### CROSS-REFERENCE TO RELATED APPLICATIONS

This application claims priority under 35 U.S.C. §119 to Korean Patent Application No. 10-2012-0111983, filed on Oct. 9, 2012, the disclosure of which is incorporated herein by reference in its entirety.

### TECHNICAL FIELD

The present invention relates to a network-based data loss prevention (DLP) solution, and more particularly, to a network-based DLP system that analyzes input network traffic to search for traffic of interest.

### BACKGROUND

Generally, a network-based DLP system filters out uninterested traffic through various filtering so as to select final traffic of interest (TOI), and uses a pattern matching technique or the like for identifying a specific application protocol of interest as in a network messenger.

However, a software-type pattern matching engine can process only hundreds Mbps-class packet, and for this reason, a dedicated hardware packet processing engine integrated with hardware was implemented.

Therefore, in the network-based DLP system, a primary hardware engine considerably narrows a range of TOI, and then, a secondary final software engine precisely analyzes a blocking and logging target.

A multi-core processor (MCP)-based pattern matching hardware engine of the related art is easy to perform session-based pattern matching for identifying an application protocol, and is relatively easy to implement.

In an MCP-based hardware engine, much time is taken in filtering based on a white list and a black list, a performance difference is large depending on the number of registered entries, there is a non-uniformity of a total packet processing time, and it is unable to ensure packet ordering that processes packets in an input order. For this reason, the MCP-based hardware engine provides only a maximum of several tens to hundreds of entries.

Further, in hash-processing a packet in units of a certain size to match the hash-processed packet with a pre-stored pattern, a related art MCP-based hardware engine performs all matching based on software when searching for a group of patterns passing by an arbitrary byte in a first byte in a payload (i.e., when pattern matching based on an offset concept). In this case, before obtaining a pattern matching result of a previous packet, the related art MCP-based hardware engine is on standby without attempting pattern matching of a next packet.

Therefore, when excessive traffic is inputted, or when high-speed traffic is continuously inputted, bottleneck occurs, and moreover, a packet is missed. For this reason, chipset down can occur, and thus, the related art MCP-based hardware engine performs only pattern matching on a 10 Gbps-class packet.

### SUMMARY

Accordingly, the present invention provides a network-based DLP system that performs all matching on packets by using a field-programmable gate array (FPGA)-based hardware engine.

In one general aspect, a network-based DLP system includes: a FPGA engine configured to include a pattern matcher that hash-processes a payload of an input packet in units of a certain size, compares a pre-stored pattern and the hash-processed packet, checks a matching rule ID and an upload channel ID corresponding to the pre-stored pattern when there is a match therebetween, adds tagging information to a header of the input packet, and outputs the packet, wherein the input packet is inputted in an in-line scheme or a mirroring scheme, and the tagging information includes the matching result, the matching rule ID, and the upload channel ID; and a MCP engine configured to include a session list filter, which receives the packet with the tagging information added thereto, determines whether the received packet is a packet of a pre-registered session, and when the received packet is the packet of the pre-registered session, performs pre-registered processing on the pre-registered session, or when the received packet is not the packet of the pre-registered session, passes the received packet, and a processor that checks the tagging information, and when the received packet is the matched packet, uploads, forwards, or drops the received packet in correspondence with the matching rule ID.

Other features and aspects will be apparent from the following detailed description, the drawings, and the claims.

### BRIEF DESCRIPTION OF THE DRAWINGS

FIG. 1 is a block diagram illustrating a network-based DLP system according to an embodiment of the present invention.

### DETAILED DESCRIPTION OF EMBODIMENTS

The advantages, features and aspects of the present invention will become apparent from the following description of the embodiments with reference to the accompanying drawings, which is set forth hereinafter. The present invention may, however, be embodied in different forms and should not be construed as limited to the embodiments set forth herein. Rather, these embodiments are provided so that this disclosure will be thorough and complete, and will fully convey the scope of the present invention to those skilled in the art. The terms used herein are for the purpose of describing particular embodiments only and are not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The present invention relates to a packet processing engine for identifying a network application protocol based on a pattern and a session, which manages pattern matching and a session flow on a minimum of 40 Gbps-class or more high-capacity traffic by using a plurality of 10 Gbps-class ports, thus increasing a pattern matching effect.

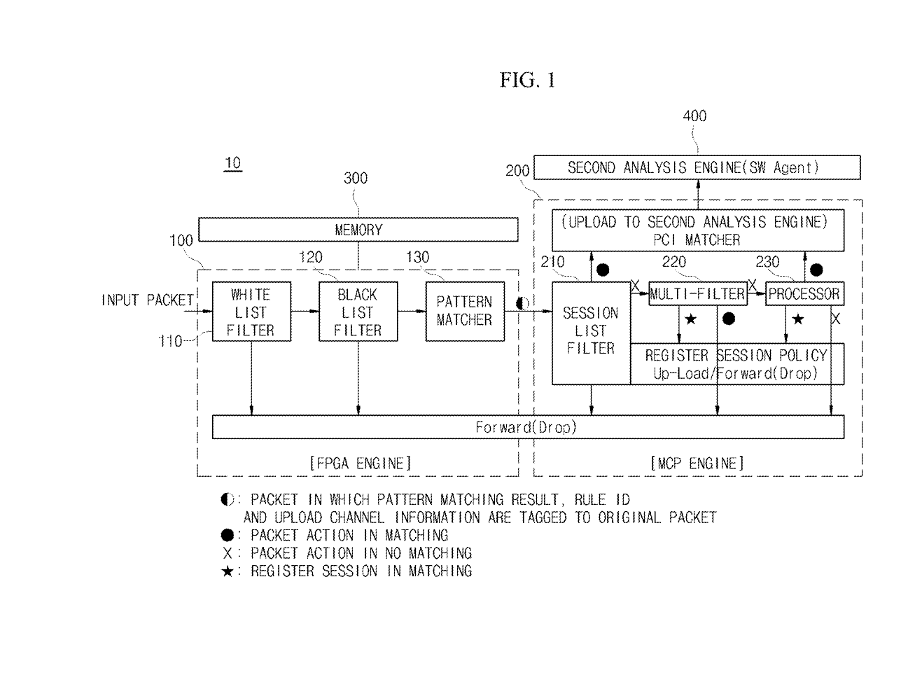

Hereinafter, embodiments of the present invention will be described in detail with reference to the accompanying drawings. FIG. 1 is a block diagram illustrating a network-based DLP system according to an embodiment of the present invention.

As illustrated in FIG. 1, a network-based DLP system 10 according to an embodiment of the present invention includes a plurality of first analysis engines 100 and 200, a memory 300, and a second analysis engine 400. Here, the first analysis engines 100 and 200 include an FPGA engine 100 and a multi-chip package (MCP) engine 200, respectively.

The network-based DLP system 10 according to an embodiment of the present invention may include an in-line mode, which is performed on a 10 GbE Internet line through a plurality of 10 GbE ports (e.g., four ports), and a mirroring mode that is performed through mirroring of a tap or a backbone switch apparatus. In the in-line mode, the network-based DLP system 10 may process all bidirectional (in/out) traffic in an in-line scheme. In the mirroring mode, the network-based DLP system 10 may process all bidirectional (in/out) traffic in a mirroring scheme.

The memory 300 is a ternary content addressable memory (TCAM), and stores a 6-tuple white list including a source Internet protocol (IP), a source port, a destination (Dst), a destination port, a packet protocol, and a physical input port number, a 6-tuple black list, a plurality of comparison target patterns which are used in pattern matching by a pattern matcher 130, comparison target data corresponding to the respective comparison target patterns, a matching rule identifier (ID), a channel ID, and a pre-registered 5-tuple session list. Here, the memory 300 stores the comparison target data at an address corresponding to a comparison target pattern (a hash value), and stores the matching rule ID and the channel ID at a location relevant to the comparison target data.

The FPGA engine 100 is an FPGA-based hardwire logic, and includes a white list filter 110, a black list filter 120, and the pattern matcher 130.

The white list filter 110 checks a 6-tuple of an input packet to pass a packet corresponding to the 6-tuple white list, but forwards (or drops) a packet which does not correspond to the 6-tuple white list. At this time, when the packet which does not correspond to the 6-tuple white list is inputted in the in-line scheme, the white list filter 110 forwards the packet to an opposite port, and when the packet is inputted in the mirroring scheme, the white list filter 110 drops the packet. These conditions are similar to the following description.

The black list filter 120 forwards (or drops) a packet corresponding to the 6-tuple black list among a plurality of packets passing through the white list filter 110, and passes a packet that does not correspond to the 6-tuple black list and has passed through the white list filter 110.

The pattern matcher 130 hash-processes a payload of a received packet in units of a certain size, and compares the hash-processed pattern and a pattern stored in the memory 300.

When the hash-processed pattern is the same as the stored pattern, the pattern matcher 130 decides a matching rule ID and a channel ID to be uploaded with reference to a pre-registered matching rule for the matched pattern.

The pattern matcher 130 tags the pattern matching result, the matching rule ID, and the channel ID to a header of the received packed, and transfers the tagged pattern matching result, matching rule ID, and channel ID to the MCP engine 200. Here, the pattern matching result includes an information bit indicating the presence of pattern matching, the matching rule ID includes a unique ID of a matching rule and an information bit indicating whether a pattern is an upload pattern, and the upload channel ID includes an information bit indicating a channel to be uploaded.

In this case, although the number of predefined entries of a pattern rule is equal to or less than a threshold number (for example, a maximum of 2048), since it is difficult to simultaneously perform hash-processing equal to the threshold number, the pattern matcher 130 classifies a plurality of packets into a certain number of pattern groups equal to or less than the threshold number, and simultaneously performs a small number of hash-processing.

For example, in performing pattern matching on a packet of 64 bytes, when initial some of 64 bytes are bytes of interest and the other bytes are included in a rule pattern group which is not checked, the pattern matcher 130 performs null-masking (00′ h) on data at a location requiring no check in the packet of 64 bytes, and hash-processes the null-masked data. First, the pattern matcher 130 simultaneously performs hash-processing on a small number of representative pattern groups in the packet of 64 bytes, and determines whether data read from an address of the memory 300 corresponding to one hash value matches a payload value (the null-masked value) for which hash-processing is not performed. When hash-unprocessed data matches the read data, the pattern matcher 130 performs pattern matching, and when there is a mismatch therebetween, the pattern matcher 130 compares a hash-unprocessed payload and data read from an address of the memory 300 corresponding to a next hash value to determine whether there is a match therebetween. Here, an attempt to perform pattern matching on each of a plurality of hash values is performed by the number of pattern groups, and a matching operation of a corresponding packet is ensured to be ended before a next packet is transferred to the pattern matcher 130.

The MCP engine 200 is an MCP-based hardware engine, and includes a session list filter 210, a multi-filter 220, and a processor 230.

The session list filter 210 determines whether a packet transferred from the FPGA engine 100 is a packet of a pre-registered session. At this time, the session list filter 210 may compare a 5-tuple (a source IP, a destination IP, a source port, a destination port, and a protocol) of the transferred packet and a 5-tuple of the pre-registered session to determine whether the transferred packet is the packet of the pre-registered session.

When the transferred packet is the packet of the pre-registered session, the session list filter 210 uploads the transferred packet to a channel to be uploaded according to a policy of a corresponding session, or forwards (or drops) the transferred packet.

When the packet transferred from the FPGA engine 100 is the packet of the pre-registered session, the session list filter 210 transfers the transferred packet to the multi-filter 220.

The multi-filter 220 filters the transferred packet by using at least one of a URI extension filter, a content type filter, and a content policy filter, and passes or forwards (or drops) the filtered packet according to filtering options of the respective filters.

Moreover, the multi-filter 220 registers a session and matching result of the filtered packet in the memory 300, and then, the session list filter 210 forwards (or drops) or uploads a packet of a corresponding session.

For example, when filtering a packet by using the URL extension filter, the multi-filter 220 may check a payload of an input packet to extract an URI, identify an extension (which is an attribute of contents) in the URI to forward (or drop) an undesired packet having a pre-registered URI, and register a session of a corresponding packet in a session list.

For another example, when filtering a packet by using the contents type filter, the multi-filter 220 may search for a content type area in a payload of an HTTP response packet among input packets, forward (or drop) a packet corresponding to a predefined specific content type, and register a session of a corresponding packet in the session list.

For another example, when filtering a packet by using a content policy filter based on a 6-tuple, the multi-filter 220 may forward (or drop) the filtered packet among input packets with reference to 6-tuple information and a policy of a predefined filtering target, and output an unfiltered packet.

The processor 230 determines whether matching is performed, on the basis of a matching result tagged to a header of the packet transferred from the multi-filter 220. When pattern matching is not performed, the processor 230 forwards (or drops) the packet.

On the basis of a pattern rule ID included in a header of a pattern-matched packet, the processor 230 determines whether to forward (or drop) or upload the packet.

When the pattern-matched packet is required to be uploaded, the processor 230 uploads the packet on the basis of an upload channel ID included in the header of the packet, but when the pattern-matched packet is required to be forwarded (or dropped), the processor 230 forwards (or drops) the packet.

The processor 230 registers a matched packet in the session list, in which case the processor 230 registers information on whether to upload or forward (or drop) the matched packet and a channel ID to be uploaded along with the matched packet. At this time, the processor 230 determines whether to register one of a request (syn)-direction session and a response-direction session among sessions of a corresponding packet according to a matching rule ID, and registers the determined-direction session and the channel ID in the session list.

The second analysis engine 400 identifies an application protocol of a packet transferred from the MCP engine 200 to analyze contents composed by the packet, and performs a predetermined security policy on the contents.

As described above, the present invention can flexibly and stably perform packet filtering and session flow management even in a 10 Gbps-class or more network environment.

Moreover, the present invention uses the FPGA and MCP-based hardware engines. Specifically, the FPGA-based hardwire engine may perform all pattern matching on high-capacity traffic to freely process the traffic, and the MCP-based hardware engine may receive the pattern matching result from the FPGA-based hardwire engine, and apply a bidirectional session-based policy, an outbound session-based policy, and an inbound session-based policy to apply the final session-unit pattern matching result. Accordingly, the present invention can reduce a packet processing load, enhance a processing speed, and enhance a pattern matching performance.

According to the present invention, packet filtering and session flow management can be flexibly and stably performed even in an environment in which 10 Gbps-class or more network traffic is transmitted and received.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A network-based data loss prevention (DLP) system comprising:
a FPGA engine configured to comprise a pattern matcher that hash-processes a payload of an input packet in units of a certain size, compares a pre-stored pattern and the hash-processed packet, checks a matching rule ID and an upload channel ID corresponding to the pre-stored pattern when there is a match therebetween, adds tagging information to a header of the input packet, and outputs the packet, wherein the input packet is inputted in an in-line scheme or a mirroring scheme, and the tagging information comprises the matching result, the matching rule ID, and the upload channel ID; and
a MCP engine configured to comprise a session list filter, which receives the packet with the tagging information added thereto, determines whether the received packet is a packet of a pre-registered session, and when the received packet is the packet of the pre-registered session, performs pre-registered processing on the pre-registered session, or when the received packet is not the packet of the pre-registered session, passes the received packet, and a processor that checks the tagging information, and when the received packet is the matched packet, uploads, forwards, or drops the received packet in correspondence with the matching rule ID.

2. The network-based DLP system of claim 1, wherein the FPGA engine further comprises a white list filter configured to check a 6-tuple of the input packet, and when the 6-tuple corresponds to a white list, pass the input packet, or when the 6-tuple of the input packet does not correspond to a 6-tuple of the white list, forward or drop the input packet.

3. The network-based DLP system of claim 1, wherein the FPGA engine further comprises a black list filter configured to pass a packet that does not correspond to a black list among a plurality of the input packets, and forward or drop a packet corresponding to the black list among the plurality of input packets.

4. The network-based DLP system of claim 1, wherein the session list filter compares a 5-tuple of the packet with the tagging information added thereto and a 5-tuple of the pre-registered session to determine whether the packet with the tagging information added thereto is the packet of the pre-registered session.

5. The network-based DLP system of claim 1, wherein the processor checks the matching result of the tagging information, and when it is determined as the matched packet, the processor forwards or drops the packet, or uploads the packet to a channel corresponding to the channel ID, according to the matching rule ID, and registers a session corresponding to the matched packet.

6. The network-based DLP system of claim 1, further comprising a memory configured to store comparison target data at an address classified as a hash value before being hash-processed as the hash value,
wherein the pattern matcher compares a certain size of the payload and the comparison target data which is stored at the address of the memory corresponding to the hash value that is obtained by hash-processing the payload of the input packet in units of the certain size, and when there is a match therebetween, the pattern matcher performs pattern matching.

7. The network-based DLP system of claim 6, wherein before receiving another input packet subsequent to the input packet for which the pattern matching is being performed, the pattern matcher ends the pattern matching on the payload of the input packet.

8. The network-based DLP system of claim 1, wherein the MCP filter further comprises a multi-filter configured to filter a packet passing through the session list filter by using various types of filters, pass a unfiltered packet, and register a session of the filtered packet passing through the session list filter.
